(19) United States
(12) Patent Application Publication
(10) Pub. No.: US 2023/0384083 A1
(43) Pub. Date: Nov. 30, 2023

(54) METHOD, MEASURING DEVICE, MACHINING SYSTEM AND COMPUTER PROGRAM PRODUCT FOR DETERMINING A CORRECTED HEIGHT SIGNAL FROM MEASUREMENT DATA OBTAINED WITH OPTICAL COHERENCE TOMOGRAPHY

(71) Applicant: Lessmüller Lasertechnik GmbH, Munchen (DE)

(72) Inventors: Eckhard Lessmüller, Munchen (DE); Christian Truckenbrodt, Munchen (DE)

(73) Assignee: Lessmüller Lasertechnik GmbH, Munchen (DE)

(21) Appl. No.: 18/201,469

(22) Filed: May 24, 2023

(30) Foreign Application Priority Data
May 24, 2022 (DE) 10 2022 113 157.2

(51) Int. Cl. G01B 9/02055; G01B 9/02091; G01B 9/02056; B23K 26/03

(52) U.S. Cl. CPC G01B 9/0207; G01B 9/02091; G01B 9/02058; B23K 26/032

(57) ABSTRACT

A method, measuring device, machining system and computer program product are provided for determining a corrected height signal from measurement data obtained with optical coherence tomography. The measurement data comprises an object signal and a background signal superimposed on the object signal, the object signal and the background signal being subject to different dispersion. A first transformation is performed comprising transforming the measurement data, the first transformation being targeted at the background signal to obtain a height signal, background components in the height signal are determined, the background components in the height signal are compensated to obtain a background-compensated height signal, an inverse transformation is performed comprising back-transforming the background-compensated height signal to obtain background-compensated measurement data, dispersion compensation for the object signal is performed to obtain dispersion-compensated and background-compensated measurement data, and a second transformation is performed comprising transforming the dispersion-compensated and background-compensated measurement data to obtain a dispersion-compensated and background-compensated height signal.

### FIELD OF THE INVENTION

The present invention relates to a method for determining a corrected height signal from measurement data obtained with optical coherence tomography. The invention further relates to a measuring device operating in accordance with such a method, a machining system comprising a measuring device, program code, and a computer program product comprising program code.

### BACKGROUND

Especially in the field of laser welding or other machining methods where workpieces are machined with a high-energy machining beam, optical coherence tomography (OCT) is used as a measuring method for characterizing a workpiece to be machined or a machining result as well as for monitoring an ongoing machining process. Optical coherence tomography is based on directing a sample beam onto a workpiece through a sample arm and causing this beam to interfere with a reference beam that is optically guided in a reference arm. In many cases, the sample beam is coupled into the machining beam and projected and/or focused onto the workpiece together with the machining beam. The sample beam may be displaceable relative to the machining beam, which enables measurements in front of, in and/or behind a process area.

In terms of optical properties, the sample arm and the reference arm are matched as closely as possible. For example, variable-length reference arms are used, allowing for readjustment when a distance to the workpiece and thus the length of the sample arm changes. Dispersion differences between the sample arm and the reference arm or their compensation also play a key role when it comes to the quality of optical coherence measurements. DE 10 2015 015 112 A1 describes a dispersion compensation device having two transmission gratings arranged at a variable distance from each other. When passing through the first transmission grating, an incident light beam is split as a function of the wavelength. The arrangement of the gratings ensures that, for example, a more strongly refracted short-wave component travels a greater distance than a less strongly refracted long-wave component, with the difference in distance being adjustable by changing the distance between the gratings. This enables to simulate the sample arm dispersion in the reference arm.

Since the exact alignment of sample arm dispersion and reference arm dispersion can be difficult under real-life conditions, in some cases software-based dispersion compensation is performed alternatively or additionally. Marks et al., for example, describe a corresponding algorithm in their paper “Digital algorithm for dispersion correction in optical coherence tomography for homogeneous and stratified media” (Applied Optics 42, 2, 204, 10 Jan. 2003).

Regardless of the chosen dispersion compensation technique, background components may appear in the acquired spectra during OCT measurements of the type described. As a result, background lines appear in the height signal obtained from the measurement data. These are caused, for example, by protective glasses or other elements in the optical setup. These background components are subject to a different dispersion than the actual object signal, i.e. the measurement signal originating from the object actually being measured, for example the workpiece under consideration.

It is desirable to remove such background components to be able to see the components of interest more clearly and evaluate them while committing fewer errors. A common approach to this is to record a static background without an OCT measurement signal, store it, and then subtract it each time an OCT measurement is performed. However, this approach is subject to a certain degree of inaccuracy because the background signal may change, for example due to changing environmental influences or minor changes to the optical setup.

It has also become apparent that when software-based dispersion compensation algorithms are used, very strong broadening of signals that are due to background components may occur upon transformation of the measurement data to a height signal. Instead of narrow high peaks, broadened low-amplitude signals occur that are difficult to distinguish from background noise and can thus only be removed with low accuracy.

### BRIEF SUMMARY OF THE INVENTION

Based on the prior art, the present invention is based on the task of simply and effectively filtering out background signals from OCT measurement signals.

This task is accomplished with a method, a measuring device, a machining system, and a computer program product having the features described herein.

In one embodiment, a method is provided for determining a corrected height signal from measurement data obtained with an optical coherence tomograph of a measuring device of a machining system for machining a workpiece using a high-energy machining beam. The method comprising obtaining measurement data based on interference of sample light guided in a sample arm and reference light guided in a reference arm, the sample arm and the reference arm differing in dispersion, the measurement data comprising an object signal and a background signal superimposed on the object signal, the object signal and the background signal being subject to different dispersion; performing a first transformation on the measurement data using a control unit of the measuring device, the first transformation being targeted at the background signal to obtain a height signal; determining background components in the height signal using the control unit of the measuring device; compensating the background components in the height signal using the control unit of the measuring device to obtain a background-compensated height signal; performing an inverse transformation comprising back-transforming the background-compensated height signal using the control unit of the measuring device to obtain background-compensated measurement data; performing dispersion compensation for the object signal using the control unit of the measuring device to obtain dispersion-compensated and background-compensated measurement data; performing a second transformation comprising transforming the dispersion-compensated and background-compensated measurement data using the control unit of the measuring device to obtain a dispersion-compensated and background-compensated height signal; and controlling the machining of the workpiece by the control unit of the measuring device based, at least in part, on the dispersion-compensated and background-compensated height signal.

In one embodiment of the method, compensating comprises subtracting a least a portion of the background components from the height signal. In another embodiment, the step of performing dispersion compensation for the background signal before the first transformation. In another embodiment, compensating comprises at least one selected from the group consisting of (i) clipping and (ii) overwriting data points of the height signal for height values not exceeding a predetermined threshold value. In one embodiment, the threshold value is a maximum of 100 μm. In another embodiment, the threshold value is a maximum of 50 μm. In one embodiment, at least one selected from the group consisting of: (i) the first transformation, (ii) the second transformation, and (iii) the inverse transformation, comprise a Fourier transformation. In another embodiment, at least one selected from the group consisting of: (i) the first transformation, (ii) the second transformation, and (iii) the inverse transformation, comprise a fast Fourier transformation. In another embodiment, performing dispersion compensation for the object signal comprises multiplying the background-compensated measurement data by a dispersion correction curve. In another embodiment, at least one method step is based on calculations which are carried out in at least one field programmable gate array. In yet another embodiment, all of the method steps are based on calculations which are carried out in at least one field programmable gate array.

In one embodiment, a measuring device is provided for a machining system for machining a workpiece using a high-energy machining beam. The measuring device comprising an optical coherence tomograph configured to generate a sample beam and a reference beam, the optical coherence tomograph comprising a sample arm in which the sample beam is optically guidable; a reference arm in which the reference beam is optically guidable; a sample unit adapted to perform optical coherence tomography measurements by causing the sample beam and the reference beam to interfere to generate measurement data. The measuring device comprising a control unit having at least one non-transitory computer readable medium having computer-readable program code portions embodied therein, the control unit having a processing device operatively coupled to the at least one non-transitory computer readable medium, wherein the processing device is configured to execute the computer-readable program code portions to obtain measurement data based on interference of sample light guided in a sample arm and reference light guided in a reference arm, the sample arm and the reference arm differing in dispersion, the measurement data comprising an object signal and a background signal superimposed on the object signal, the object signal and the background signal being subject to different dispersion; perform a first transformation on the measurement data, the first transformation being targeted at the background signal to obtain a height signal; determine background components in the height signal; compensate the background components in the height signal to obtain a background-compensated height signal; perform an inverse transformation comprising back-transforming the background-compensated height signal to obtain background-compensated measurement data; perform dispersion compensation for the object signal to obtain dispersion-compensated and background-compensated measurement data; perform a second transformation comprising transforming the dispersion-compensated and background-compensated measurement data using the control unit of the measuring device to obtain a dispersion-compensated and background-compensated height signal; and control the machining of the workpiece by the machining system based, at least in part, on the dispersion-compensated and background-compensated height signal.

In one embodiment, the measuring device comprises a control unit comprising at least one field programmable gate array and wherein the control of the machining of the workpiece by the machining system is based on calculations made in the at least one field programmable gate array. In another embodiment, compensating comprises subtracting a least a portion of the background components from the height signal. In another embodiment, the processing device is configured to execute the computer-readable program code portions to perform dispersion compensation for the background signal before the first transformation. In another embodiment, compensating comprises at least one selected from the group consisting of (i) clipping and (ii) overwriting data points of the height signal for height values not exceeding a predetermined threshold value. In one embodiment, the threshold value is a maximum of 100 μm. In another embodiment, the threshold value is a maximum of 50 μm. In one embodiment, at least one selected from the group consisting of: (i) the first transformation, (ii) the second transformation, and (iii) the inverse transformation, comprise a Fourier transformation. In another embodiment, at least one selected from the group consisting of: (i) the first transformation, (ii) the second transformation, and (iii) the inverse transformation, comprise a fast Fourier transformation. In another embodiment, performing dispersion compensation for the object signal comprises multiplying the background-compensated measurement data by a dispersion correction curve. In another embodiment, the processing device is configured to execute the computer-readable program code portions in at least one field programmable gate array.

In one embodiment of the machining system for machining a workpiece using a high-energy machining beam comprises a measuring device as described herein; and a machining device comprising a machining beam source configured to generate the machining beam and machining beam optics configured to at least one selected from the group consisting of project and focus the machining beam onto the workpiece.

In one embodiment, a computer program product is provided for determining a corrected height signal from measurement data obtained with an optical coherence tomograph of a measuring device of a machining system for machining a workpiece using a high-energy machining beam. The computer program product comprising at least one non-transitory computer readable medium having computer-readable program code portions embodied therein, the computer-readable program code portions comprising executable portions for obtaining measurement data based on interference of sample light guided in a sample arm and reference light guided in a reference arm, the sample arm and the reference arm differing in dispersion, the measurement data comprising an object signal and a background signal superimposed on the object signal, the object signal and the background signal being subject to different dispersion; performing a first transformation on the measurement data, the first transformation being targeted at the background signal to obtain a height signal; determining background components in the height signal; compensating the background components in the height signal to obtain a background-compensated height signal; performing an inverse transformation comprising back-transforming the background-compensated height signal to obtain background-compensated measurement data; performing dispersion compensation for the object signal to obtain dispersion-compensated and background-compensated measurement data; performing a second transformation comprising transforming the dispersion-compensated and background-compensated measurement data using the control unit of the measuring device to obtain a dispersion-compensated and background-compensated height signal; and controlling the machining of the workpiece by the machining system based, at least in part, on the dispersion-compensated and background-compensated height signal.

In one embodiment, the computer program product comprises computer-readable program code portions comprising executable portions for performing dispersion compensation for the background signal before the first transformation. In another embodiment, compensating comprises subtracting a least a portion of the background components from the height signal. In another embodiment, compensating comprises at least one selected from the group consisting of (i) clipping and (ii) overwriting data points of the height signal for height values not exceeding a predetermined threshold value. In one embodiment, the threshold value is a maximum of 100 μm. In another embodiment, the threshold value is a maximum of 50 μm. In one embodiment, at least one selected from the group consisting of: (i) the first transformation, (ii) the second transformation, and (iii) the inverse transformation, comprise a Fourier transformation. In another embodiment, at least one selected from the group consisting of: (i) the first transformation, (ii) the second transformation, and (iii) the inverse transformation, comprise a fast Fourier transformation. In another embodiment, performing dispersion compensation for the object signal comprises multiplying the background-compensated measurement data by a dispersion correction curve. In another embodiment, the computer program product comprises computer-readable program code portions comprising executable portions for performing calculations in at least one field programmable gate array.

The invention provides for dual transformation of measurement data. First, a height signal is calculated from measurement data, in some embodiments using dispersion compensation parameters optimized for background signals. Subsequently, inverse transformation is performed. The back-transformed data are dispersion-compensated. Dispersion compensation parameters that are optimized for the actual signal rather than, for example, the background may be used for this purpose. Subsequently, another height signal is calculated. Instead of performing dispersion compensation and transformation which optimally refines the height signal originating from the actual measurement but results in a broadened background signal that is difficult to remove, initial considerations focus on the background in a first transformation. This makes background components easy to detect and remove with high accuracy. Only in the next step, when inverse transformation is completed, is the actual signal, i.e. the object signal, considered. The resulting background-compensated height signal is of high quality since the background has been factored out effectively.

The invention relates to a method for determining a corrected height signal from measurement data obtained with optical coherence tomography. The measurement data are based on interference of sample light guided in a sample arm and reference light guided in a reference arm, the sample arm and the reference arm differing in dispersion. The measurement data comprise an object signal and a background signal superimposed on the object signal, the object signal and the background signal being subject to different dispersion. The method comprises the step of obtaining the measurement data. The method further comprises the step of performing a first transformation comprising transforming the measurement data, the first transformation being targeted at the background signal, thus obtaining a height signal. The method further comprises the steps of determining background components in the height signal, compensating the background components in the height signal, thus obtaining a background-compensated height signal, and performing inverse transformation comprising back-transforming the background-compensated height signal, thus obtaining background-compensated measurement data. The method further comprises performing dispersion compensation for the object signal, thus obtaining dispersion-compensated and background-compensated measurement data. The method further comprises performing a second transformation comprising transforming the dispersion-compensated and background-compensated measurement data, thus obtaining a dispersion-compensated and background-compensated height signal.

The features according to the invention allow background signals to be easily and effectively filtered out from OCT measurement signals. The actual object signal can thus be determined with less uncertainty. This avoids any problems and inaccuracies in relation to the use of a static background that is subtracted from measurement data. In addition, software-based dispersion compensation may also be applied to measurements with significant background components without the background components overshadowing the data too strongly. The invention makes it possible to perform background correction even for measurement setups in which a static OCT background component is subject to dispersion that clearly differs from that of the actual object signal.

The measurement data may be obtained before, during and/or after machining a workpiece with a high-energy machining beam such as a machining laser. Machining may be performed using a feed. For example, the machining beam is moved relative to the workpiece along a machining path that may define a constant or a variable machining direction. A constant or a variable feed rate may be used. A sample beam from which the sample light originates may be directed onto the workpiece to acquire the measurement data. A reference beam from which the reference light originates may run in the reference arm at the same time. The sample beam and/or the reference beam are generated in an optical coherence tomograph, for example. The sample beam may be displaceable relative to the machining beam, in particular in one or also in two spatial directions, e.g. parallel and/or transverse to a machining direction. To measure a penetration depth of the machining beam into the workpiece during machining, which can be useful, for example, for monitoring processes and/or controlling and/or regulating process parameters, the sample beam may be directed into a keyhole that forms as a result of the machining beam's interaction with the workpiece.

The sample beam and the reference beam may be generated from a source beam, in particular a broadband low-coherence light beam, using a beam splitter. The optical coherence tomograph may comprise a sample light source adapted to generate the source beam.

The object signal is in particular a signal originating from the measurement on the workpiece. The background signal is in particular a signal caused by optical elements of an optical setup, for example by reflection in protective glasses, windows or the like. The background signal may be substantially static. Together, the object signal and the background signal may form a measurement signal, i.e., an overall signal obtained in the course of the measurement or at least a part thereof.

The first transformation and/or the second transformation generate a height signal from the measurement data or the dispersion-compensated and background-compensated measurement data, i.e., a spectrum having a certain signal amplitude as a function of height. The height is to be interpreted as the height at the measuring point. The height signal thus provides a height reading. If height measurements are carried out over time, they can be used to determine how the measured height at a specific measuring point develops over this time, which is useful, for example, for measuring penetration depth. Alternatively or additionally, this may serve to determine a height profile. For this purpose, for example, measurements are carried out in specific measuring positions at specific defined times, and a respective height value is recorded. Plotting the obtained height values over the measurement position renders a height profile.

Dispersion compensation may be performed in accordance with at least one predeterminable and/or predetermined dispersion compensation parameter. The dispersion compensation parameter may allow to adjust how dispersion compensation is to be performed. In a given system comprising dispersion compensation software, it can be empirically determined for which dispersion compensation parameters a particularly strong dispersion-corrected signal can be obtained in the range of the expected height value. Likewise, it can be empirically determined for which dispersion compensation parameter background components become particularly apparent. In this respect, the invention does not exclusively refer to nor is it limited to particular dispersion compensation parameters or particular algorithms. The decisive factor is to first consider and correct the background and then, after the correction, to carry out dispersion compensation for the object signal.

Depending on the software used, multiple dispersion compensation parameters may be predeterminable. Any reference to a dispersion compensation parameter in the context of this disclosure shall equate any reference to at least one dispersion compensation parameter, i.e. there may be multiple parameters.

The first transformation and/or the second transformation and/or the inverse transformation may comprise a Fourier transformation, in particular a fast Fourier transformation. This ensures a high degree of computational efficiency.

Performing dispersion compensation for the object signal comprises multiplying the background-compensated measurement data by a dispersion correction curve. The dispersion correction curve may be static. In particular, the dispersion correction curve comprises a real part and an imaginary part. Multiplication may provide a complex signal. Multiplication may cause a phase shift. The dispersion compensation parameters may comprise dispersion coefficients. In some embodiments, the dispersion coefficients can be used to define a polynomial expression that is usable as an argument for a function defining the dispersion correction curve.

Compensating may comprise subtracting a least a portion of the background components from the height signal. This at least partially removes the unwanted background. Subtraction may include setting specific height values to zero. Alternatively or additionally, subtraction may include modeling of single or multiple peaks in the height signal. For example, they can be approximated by choosing a suitable function as well as suitable function parameters. Subsequently, values provided by the obtained function can be subtracted at least in certain value ranges.

In some embodiments, the method may further comprise the step of performing dispersion compensation for the background signal before the first transformation. Performing such dispersion compensation may comprise, as with dispersion compensation for the object signal, multiplying by a suitable dispersion correction curve and/or be defined by at least one dispersion correction parameter. Such dispersion correction curve and/or such dispersion correction parameter may be optimized for the background signal.

Background peaks are very easy to detect especially if no dispersion compensation is performed before the first transformation. In other words, the measurement data processed during the first transformation are not dispersion-compensated. In this case, the background peaks are very narrow and thus easy to subtract.

Certain background components can be removed particularly reliably if compensating comprises clipping and/or overwriting data points of the height signal for height values not exceeding a predetermined threshold value. In some cases, it may be appropriate if the threshold value is a maximum of 100 μm and in particular a maximum of 50 μm. Many background peaks appear in the area below the threshold value, whereas relevant measurement information appears above the threshold value. By simply clipping or overwriting in the lower range, many background components can thus already be removed in a first step without requiring further adjustments or calculations.

The aforementioned method steps may be performed in a partially automated or automated manner. In some embodiments, at least one and in particular all of said method steps are based on calculations which are carried out in at least one field programmable gate array. This ensures a high degree of computational efficiency. A dispersion-compensated and background-compensated height signal can then already be supplied to a control software executed in a computer while no dispersion compensation needs to be performed in the computer.

The invention further relates to a measuring device, in particular for a machining system for machining a workpiece using a high-energy machining beam. The measuring device comprises an optical coherence tomograph adapted to generate a sample beam and a reference beam. The optical coherence tomograph comprises a sample arm in which the sample beam is optically guidable, a reference arm in which the reference beam is optically guidable, a sample unit adapted to perform optical coherence tomography measurements by causing the sample beam and the reference beam to interfere to generate measurement data, and a control unit. It is understood that here the sample beam may provide sample light and/or the reference beam may provide reference light. The control unit is programmed to perform a method according to the invention, in particular in a partially automated or automated manner, to determine a dispersion-compensated and background-compensated height signal from the measurement data.

The invention further relates to a machining system for machining a workpiece using a high-energy machining beam. The machining system comprises a measuring device according to the invention and a machining device. The machining device comprises a machining beam source adapted to generate the machining beam and machining beam optics adapted to project and/or focus the machining beam onto the workpiece.

The machining device may comprise an industrial robot and/or be partially or completely arranged on an industrial robot. The machining device may comprise a machining head. The machining head may be carried by an industrial robot. During machining, a feed of the workpiece relative to the machining beam optics may be provided, which may be generated by moving the workpiece and/or by moving the machining beam optics and the machining head, respectively.

A machining scanner that makes the machining beam displaceable relative to the workpiece may be provided. The machining scanner may allow a machining position on the workpiece to shift in one or two spatial directions. For example, the machining scanner may have at least one and in particular two movable mirrors by means of which the machining beam can be displaced in a targeted manner.

The sample beam may be coupleable into the machining beam and/or into the machining beam optics. A sample scanner that makes the sample beam displaceable relative to the machining beam or relative to the spot pattern may be provided. In addition to the sample scanner, the machining scanner may be used to displace the sample beam. In this configuration, for example, the machining beam is guided via the machining scanner rather than the sample scanner, and the sample beam is guided via both the sample scanner and the machining scanner. Thus, the sample beam may be displaceable relative to the machining beam by means of the sample scanner, even if the machining scanner is being moved.

The invention further relates to program code comprising instructions which, when executed by a processor, cause a method according to the invention to be performed. The program code may be intended to be executed/computed in a graphics processing unit (GPU) and/or a microcontroller and/or a field programmable gate array (FPGA). The calculations underlying the method can thus be made independently of a computer and/or by any processor.

The invention further relates to a computer program product comprising a machine-readable medium on which program code according to the invention is stored. The machine-readable medium may be any memory. The machine-readable medium may in particular be a flash memory, an EEPROM (electrically erasable programmable read-only memory) or any other memory from which an FPGA may load a configuration. The computer program product may thus be intended for use with a computer or also for use with a GPU, FPGA or microcontroller.

In particular, it is pointed out that all features and properties described with respect to devices as well as procedures can be applied mutatis mutandis to methods according to the invention and are applicable in the sense of the invention and deemed to be disclosed as well. The same applies vice versa. This means that structural features, i.e. features according to the device, mentioned with respect to methods can also be taken into account, claimed as well as deemed to be disclosed within the scope of the device claims.

Below, the present invention is described by way of example with reference to the accompanying figures. The drawings, description and claims contain numerous features in combination. The skilled person will appropriately consider the features also individually and reasonably use them in combination within the scope of the claims.

### BRIEF DESCRIPTION OF THE DRAWINGS

FIG. 1 is a schematic representation of a machining system for machining a workpiece using a high-energy machining beam, comprising a measuring device by means of which OCT measurement data can be generated;

FIG. 2 is a visualization of an example of a transformation of measurement data into a height signal;

FIG. 3 shows an example of a height signal;

FIG. 4 shows another example of a height signal;

FIG. 5 shows a background-compensated height signal;

FIG. 6 shows an example of background-compensated measurement data;

FIG. 7 shows an example of a dispersion correction curve;

FIG. 8 shows an example of a complex signal; and

FIG. 9 is a sequence diagram of background compensation of measurement data.

### DETAILED DESCRIPTION OF EMBODIMENTS OF THE INVENTION

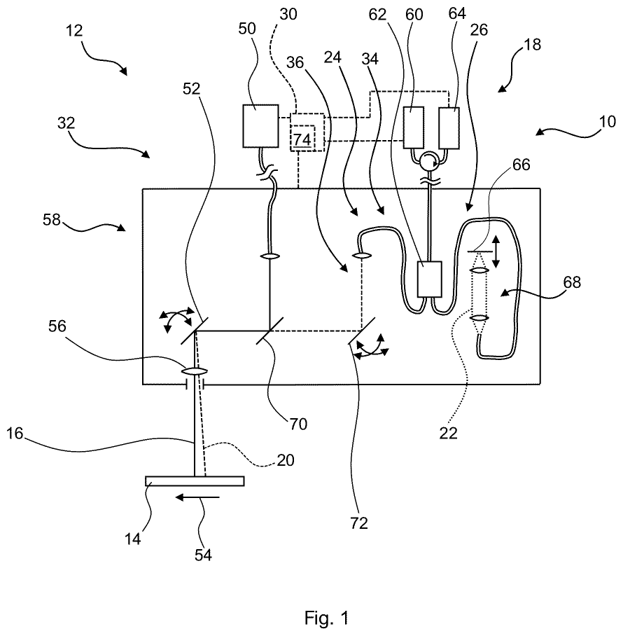

FIG. 1 illustrates a machining system 12 comprising a measuring device 10 and a machining device 32. The machining device 32 comprises a machining beam source 50 configured as a machining laser. It generates a machining beam 16 which can be directed onto a workpiece 14 for machining of the latter. This can be, for example, a machining laser beam.

The machining device 32 comprises a machining scanner 52 that makes the machining beam 16 displaceable. The machining scanner 52 comprises, for example, a mirror arrangement that makes the machining beam 16 automatically displaceable in two spatial directions, e.g. parallel and transverse to a machining direction 54. The machining beam 16 is focused onto the workpiece 14 via a schematically illustrated machining beam optics 56 of the machining device 32.

In the present case, the machining device 32 includes a machining head 58 that may be attached to an industrial robot, for example, which is not shown.

The machining system 12 further comprises a measuring device 10. The measuring device 10 comprises an optical coherence tomograph 18. The optical coherence tomograph 18 comprises a sample beam source 60 and a beam splitter 62 coupled thereto. A sample arm 24 and a reference arm 26 extend from the beam splitter 62. A sample beam 20 is optically guided in the sample arm 24. A reference beam 22 is optically guided in the reference arm 26.

The sample arm 24 and the reference arm 26 are connected to a sample unit 64, within which the sample beam 20 and the reference beam 22 interfere with each other. In the case shown, the sample unit 64 comprises a spectrometer enabling optical coherence measurements on the basis of the interference of the sample beam 20 and the reference beam 22. These measurements allow optical coherence tomography to be carried out, for example to determine a height or depth profile of a portion of the workpiece 14 to be machined and/or already machined and/or currently being machined. It is also possible, for example, to determine a penetration depth of the machining beam 16 into the workpiece 14, in particular into a vapor cavity (also known as “keyhole”) that is formed.

The sample arm 24 extends from the beam splitter 62 to the workpiece 14. The reference arm 26 extends from the beam splitter 62 to its end at which a reflector 66 is arranged. In the case shown, the reflector 66 is a mirror belonging to a path length adjustment unit 68 that makes an optical path length of the reference arm 26 adjustable. This allows the optical path length of the reference arm 26 to be adjusted to the optical path length of the sample arm 24.

The sample beam 24 is coupleable into the machining beam 16. In the case shown, the sample beam 20 is guided to a partially transparent mirror 70. It deflects the machining beam 16 and allows the sample beam 24 to be coupled into the machining beam 16.

The measuring device 10 further comprises a sample scanner 72. The sample scanner 72 comprises, for example, a mirror arrangement that makes the sample beam 20 automatically displaceable in two spatial directions, e.g. parallel and transverse to the machining direction 54. In the present machining system 12, the sample beam 20 is deflectable relative to the machining beam 16 so that impact positions of the two beams can be set independently of one another. As can be seen in FIG. 1, the sample scanner 72 only deflects the sample beam 20 whereas the machining scanner 52 deflects both the machining beam 16 and the sample beam 20. This enables the aforementioned independent displacement of machining the beam 16 and the sample beam 20.

In addition, a control unit 30 is provided. It may be part of the measuring device 10. The measuring device 10 and the machining device 32 may have separate control units. The control unit 30 shown as an example in FIG. 1 is a common control unit controlling the components of the machining system 12.

The control unit 30 may be adapted to perform the method described herein. It may have appropriate programming or program code for this purpose. In particular, a computer program product 74 comprising a machine-readable medium such as a flash memory or an EEPROM may be provided. The program code may be stored thereon. It is in particular intended to be executed in a graphics processing unit (GPU) and/or a microcontroller and/or a field programmable gate array (FPGA).

In some embodiments, the calculations underlying the method described are made entirely in one or more field programmable gate arrays (FPGA). They may be part of the control unit 30.

The design of the measuring device 10 is to be understood as exemplary. In particular, the method for determining a corrected height signal as described below is in principle appliable to any measuring systems supplying OCT measurement data.

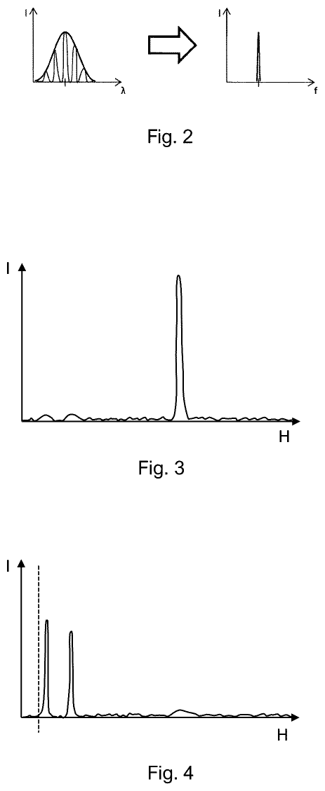

Below, the determination of a corrected height signal is described. First, measurement data are obtained with optical coherence tomography. In the example shown, this is done with the measuring device 10. The measurement data are available in the form of a spectrum as illustrated in FIG. 2. A height signal can be obtained from the measurement data in a way that is generally known by performing suitable transformation, such as fast Fourier transformation (FFT). Such height signal has a height-dependent intensity. FIG. 2 shows an example of a height signal with a single peak at a specific height value. Here, for example, a certain height value or distance value was measured, e.g. a specific penetration depth.

FIG. 3 shows an example of a height signal as conventionally obtained upon transformation of measurement data. The measurement data contain both an object signal resulting from the measurement on the workpiece 14 and a background signal resulting from an at least essentially static measurement background due to, for example, protective glasses or the like. Based on such measurement data, software-based dispersion compensation was performed to obtain the height signal shown in FIG. 3. For this purpose, a dispersion compensation parameter was selected which causes dispersion compensation for the object signal. The result is a pronounced peak in the range of medium height values, which is attributable to the object signal. Further, what is apparent in the example are the two broad peaks of low intensity in the range of low height values. They are due to the background signal. While dispersion compensation that was targeted at the object signal was performed, the background peaks were broadened, which made them difficult to distinguish from the background noise.

FIG. 4 shows the procedure according to a method described herein. Here, measurement data are first transformed using a transformation that is targeted at the background. For this purpose, either no dispersion compensation is performed or dispersion compensation is performed before the transformation that makes the background signal more prominent. The latter case will be discussed below. In the example shown, this results in two narrow large-amplitude background peaks that are easy to recognize and isolate. In the range of the object signal, on the other hand, a broadened peak occurs that is rather difficult to isolate. This is no problem, however, since the method initially deals only with the background signal.

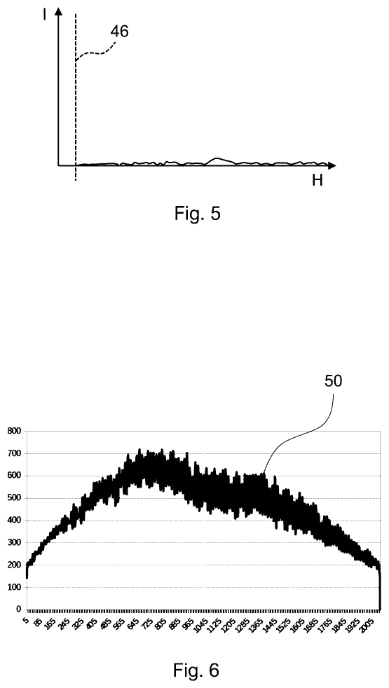

FIG. 5 illustrates the height signal of FIG. 4 after parts of the background have been subtracted. Generally speaking, background components are compensated. First, the height signal is clipped below a threshold value 46. The values of the height signal are thus set to zero below the threshold value 46. This is 50 μm, for example. In a penetration depth measurement, for example, no such low values are expected for the object signal, i.e. the signal related to the penetration depth. Therefore, clipping the height signal is no problem for the object signal, yet it already removes a significant portion of the background signal easily and reliably. However, it is understood that such threshold-based clipping is purely optional and may be omitted depending on the measurement situation and the desired measurement information.

In addition, background subtraction is performed by compensating the detected background peaks of the height signal. This can be done by partial or complete subtraction of the background peaks. For this purpose, any suitable method for subtracting individual peaks from spectra may be applied in a generally known manner. For example, the peaks may be fitted and the functions modeled in the process may be subtracted. Also, maxima of the peaks may be searched and peak widths may be determined, and based on this, peaks to be subtracted may be modeled.

By subtracting at least part of the background signal, the background-compensated height signal shown in FIG. 5 is obtained. In the next step, it may be back-transformed to obtain background-compensated measurement data. In another transformation, a height signal may be obtained again from these data, performing dispersion compensation that is targeted at the object signal is this time.

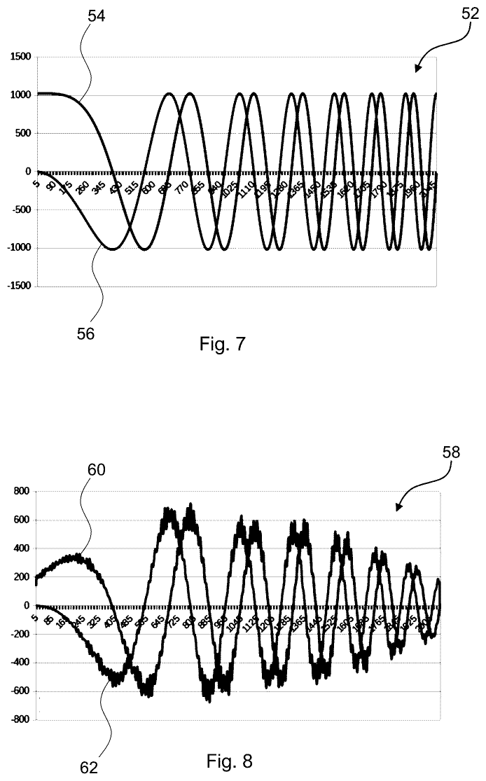

FIG. 6 shows an example of background-compensated measurement data 50 obtained by proceeding as described above.

FIG. 7 shows an example of a dispersion correction curve 52. In the present case, the dispersion correction curve is a complex curve. It comprises a real part 54 and an imaginary part 56. For example, the real part is a cosine function, and the imaginary part is a negative sine function. A second-degree polynomial is used as the argument of each of these functions. The dispersion correction curve defines a phase shift that is adjustable by dispersion compensation parameters. The dispersion compensation parameters may be coefficients of the mentioned polynomial.

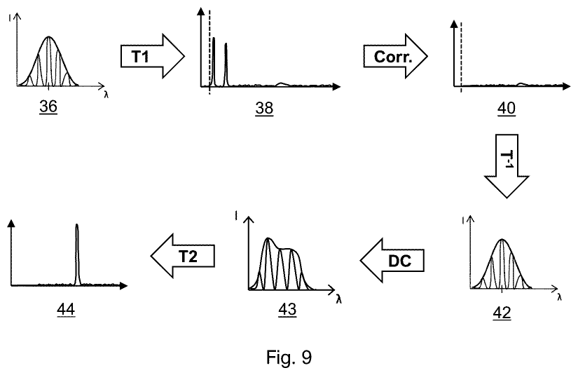

Multiplying the measurement data 50 shown in FIG. 6 by the complex dispersion correction curve 52 shown in FIG. 7 produces a complex signal 58, which is shown by way of example in FIG. 8. It comprises a real part 60 and an imaginary part 62.

To obtain a dispersion-compensated and background-compensated height signal, the complex signal 58 obtained by the multiplication is subjected to a fast Fourier transformation.

It is understood that in analogy to this, a dispersion correction curve may be used before the first transformation targeted at the background signal. Such curve may be selected in such a way that it effects dispersion compensation primarily for the background signal. In the example shown, however, no dispersion compensation is performed before the first transformation.

FIG. 9 illustrates the entire procedure again. First, measurement data 36 are obtained and transformed to a height signal 38 in a first transformation (T1) that is targeted at the background signal. In some embodiments, dispersion correction may be performed before the first transformation (T1). In the height signal 38, background components are compensated as described above, which produces a background-compensated height signal 40 (Corr.). This is back-transformed (T−1) to obtain background-compensated measurement data 42. The background-compensated measurement data 42 are dispersion-corrected, which produces dispersion-corrected and background-compensated measurement data 43. In a second transformation (T2), a dispersion-compensated and background-compensated height signal 44 is obtained from the dispersion-compensated and background-compensated measurement data 43.

If a dispersion compensation software is used in which the dispersion compensation behavior can be controlled by presetting a certain value of a dispersion compensation parameter, the following procedure is followed. Before performing the first transformation, a first value of the dispersion compensation parameter is selected that causes dispersion compensation for the background signal. In particular, this may include the absence of dispersion compensation, meaning that the selected value causes no dispersion compensation. Before performing the second transformation, however, a second value of the dispersion compensation parameter is selected that differs from the first value and causes dispersion compensation for the object signal.

By performing two transformations in a row as described, a background signal can first be easily detected and reliably compensated before, following inverse transformation, the measurement data corrected in this way are dispersion-compensated and then transformed in such a way that the object signal emerges.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EEPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions or executable portions embodied therein.

It will also be understood that one or more computer-executable program code portions or instruction code for carrying out or performing the specialized operations of the present invention may be required on the specialized computer include object-oriented, scripted, and/or unscripted programming languages, such as, for example, Java, Perl, Smalltalk, C++, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method for determining a corrected height signal from measurement data obtained with an optical coherence tomograph of a measuring device of a machining system for machining a workpiece using a high-energy machining beam, the method comprising:
obtaining measurement data based on interference of sample light guided in a sample arm and reference light guided in a reference arm, the sample arm and the reference arm differing in dispersion, the measurement data comprising an object signal and a background signal superimposed on the object signal, the object signal and the background signal being subject to different dispersion;
performing a first transformation on the measurement data using a control unit of the measuring device, the first transformation being targeted at the background signal to obtain a height signal;
determining background components in the height signal using the control unit of the measuring device;
compensating the background components in the height signal using the control unit of the measuring device to obtain a background-compensated height signal;
performing an inverse transformation comprising back-transforming the background-compensated height signal using the control unit of the measuring device to obtain background-compensated measurement data;
performing dispersion compensation for the object signal using the control unit of the measuring device to obtain dispersion-compensated and background-compensated measurement data;
performing a second transformation comprising transforming the dispersion-compensated and background-compensated measurement data using the control unit of the measuring device to obtain a dispersion-compensated and background-compensated height signal; and
controlling the machining of the workpiece by the control unit of the measuring device based, at least in part, on the dispersion-compensated and background-compensated height signal.

2. The method of claim 1, wherein said compensating comprises subtracting a least a portion of the background components from the height signal.

3. The method of claim 1, further comprising the step of performing dispersion compensation for the background signal before the first transformation.

4. The method of claim 1, wherein compensating comprises at least one selected from the group consisting of (i) clipping and (ii) overwriting data points of the height signal for height values not exceeding a predetermined threshold value.

5. The method of claim 4, wherein the threshold value is a maximum of 100 μm.

6. The method of claim 4, wherein the threshold value is a maximum of 50 μm.

7. The method of claim 1, wherein at least one selected from the group consisting of: (i) the first transformation, (ii) the second transformation, and (iii) the inverse transformation, comprise a Fourier transformation.

8. The method of claim 1, wherein at least one selected from the group consisting of: (i) the first transformation, (ii) the second transformation, and (iii) the inverse transformation, comprise a fast Fourier transformation.

9. The method of claim 1, wherein performing dispersion compensation for the object signal comprises multiplying the background-compensated measurement data by a dispersion correction curve.

10. The method of claim 1, wherein at least one method step is based on calculations which are carried out in at least one field programmable gate array.

11. The method of claim 1, wherein all of said method steps are based on calculations which are carried out in at least one field programmable gate array.

12. A measuring device for a machining system for machining a workpiece using a high-energy machining beam, comprising:
an optical coherence tomograph configured to generate a sample beam and a reference beam, comprising;
a sample arm in which the sample beam is optically guidable;
a reference arm in which the reference beam is optically guidable;
a sample unit adapted to perform optical coherence tomography measurements by causing the sample beam and the reference beam to interfere to generate measurement data; and
a control unit having at least one non-transitory computer readable medium having computer-readable program code portions embodied therein, the control unit having a processing device operatively coupled to the at least one non-transitory computer readable medium, wherein the processing device is configured to execute the computer-readable program code portions to:
obtain measurement data based on interference of sample light guided in a sample arm and reference light guided in a reference arm, the sample arm and the reference arm differing in dispersion, the measurement data comprising an object signal and a background signal superimposed on the object signal, the object signal and the background signal being subject to different dispersion;
perform a first transformation on the measurement data, the first transformation being targeted at the background signal to obtain a height signal;
determine background components in the height signal;
compensate the background components in the height signal to obtain a background-compensated height signal;
perform an inverse transformation comprising back-transforming the background-compensated height signal to obtain background-compensated measurement data;
perform dispersion compensation for the object signal to obtain dispersion-compensated and background-compensated measurement data;
perform a second transformation comprising transforming the dispersion-compensated and background-compensated measurement data using the control unit of the measuring device to obtain a dispersion-compensated and background-compensated height signal; and
control the machining of the workpiece by the machining system based, at least in part, on the dispersion-compensated and background-compensated height signal.

13. The measuring device of claim 12, wherein the control unit comprises at least one field programmable gate array and wherein the control of the machining of the workpiece by the machining system is based on calculations made in the at least one field programmable gate array.

14. The measuring device of claim 12, wherein compensating comprises subtracting a least a portion of the background components from the height signal.

15. The measuring device of claim 12, wherein the processing device is configured to execute the computer-readable program code portions to perform dispersion compensation for the background signal before the first transformation.

16. The measuring device of claim 12, wherein compensating comprises at least one selected from the group consisting of (i) clipping and (ii) overwriting data points of the height signal for height values not exceeding a predetermined threshold value.

17. The measuring device of claim 16, wherein the threshold value is a maximum of 100 μm

18. A machining system for machining a workpiece using a high-energy machining beam, comprising:
a measuring device according to claim 12; and
a machining device comprising a machining beam source configured to generate the machining beam and machining beam optics configured to at least one selected from the group consisting of project and focus the machining beam onto the workpiece.

19. A computer program product for determining a corrected height signal from measurement data obtained with an optical coherence tomograph of a measuring device of a machining system for machining a workpiece using a high-energy machining beam, the computer program product comprising at least one non-transitory computer readable medium having computer-readable program code portions embodied therein, the computer-readable program code portions comprising executable portions for:
obtaining measurement data based on interference of sample light guided in a sample arm and reference light guided in a reference arm, the sample arm and the reference arm differing in dispersion, the measurement data comprising an object signal and a background signal superimposed on the object signal, the object signal and the background signal being subject to different dispersion;
performing a first transformation on the measurement data, the first transformation being targeted at the background signal to obtain a height signal;
determining background components in the height signal;
compensating the background components in the height signal to obtain a background-compensated height signal;
performing an inverse transformation comprising back-transforming the background-compensated height signal to obtain background-compensated measurement data;
performing dispersion compensation for the object signal to obtain dispersion-compensated and background-compensated measurement data;
performing a second transformation comprising transforming the dispersion-compensated and background-compensated measurement data using the control unit of the measuring device to obtain a dispersion-compensated and background-compensated height signal; and
controlling the machining of the workpiece by the machining system based, at least in part, on the dispersion-compensated and background-compensated height signal.

20. The computer program product of claim 19, wherein the computer-readable program code portions comprising executable portions for performing dispersion compensation for the background signal before the first transformation.
